(19) United States
(12) Patent Application Publication
(10) Pub. No.: US 2005/0017487 A1
(43) Pub. Date: Jan. 27, 2005

(54) Vehicle speed related algorithm for an inflatable restraint system

(75) Inventor: Robert M. Andres, Troy, MI (US)

Correspondence Address: SIEMENS CORPORATION;INTELLECTUAL PROPERTY LAW DEPARTMENT, 170 WOOD AVENUE SOUTH, ISELIN, NJ, 08830, US

(73) Assignee: Siemens VDO Automotive Corporation

(21) Appl. No.: 10/820,289

(22) Filed: Apr. 8, 2004

Related U.S. Application Data
(60) Provisional application No. 60/490,410, filed on Jul. 25, 2003.

(51) Int. Cl. B60R 21/32

(52) U.S. Cl. 280/735

(57) ABSTRACT

An air bag system (12) includes a controller (14), a remote satellite sensor (16), a deployable air bag (18), and a vehicle speed sensor (24). Controller logic for deployment discrimination of an impact event for an airbag deployment command is sensitized when the vehicle is moving and desensitized when the vehicle is stationary.

The present application claims priority to U.S. Provisional Patent Application Ser. No. 60/490,410, filed 25 Jul. 2003.

### BACKGROUND OF THE INVENTION

The present invention relates to an inflatable restraint system, and more particularly to an algorithm which discriminates a deploy side impact event from a non-deploy side impact event for a side air bag system.

A conventional supplemental inflatable restraint often includes a side impact air bag installed inside a vehicle seat or inner portion of a vehicle door. When a side impact is detected, gas is instantaneously blown out from the gas generating device into the bag so that the bag is inflated between the side of the vehicle and the passenger. With the bag disposed between the side of the vehicle and the passenger in the vehicle, the shock applied to the passenger caused by the deformed door and the like is absorbed by the bag to protect the passenger.

In conventional side impact air bag system, the bag inflates in a direction substantially perpendicular to an input of side impact when the side impact occurs, therefore, the air bag is required to be inflated within a very short period of time with a high pressure in order to positively inflate the bag in a narrow space between the vehicle door and the passenger.

Proper discrimination of must-deploy side impact events from other non-deploy events and abuse events may be difficult due to the aggressive deploy times required to properly deploy the airbag through the gap between the passenger and the side of the vehicle. It may be especially challenging to activate restraints in response to contact with stationary objects, such as poles or trees, while not deploying on certain static abuse events such as extreme door slams or hammer impacts.

Accordingly, it is desirable to provide an air bag system, which effectively discriminates a must-deploy side impact event from non-deploy events.

### SUMMARY OF THE INVENTION

The air bag system according to the present invention includes a controller, one or more remote satellite sensors, a vehicle speed sensor and a deployable air bag. A deployment algorithm is sensitized when the vehicle is moving and desensitized when the vehicle is stationary.

It is not possible for a stationary vehicle to crash into a stationary object. While stationary, the concern is only that other objects may impact the vehicle. In the desensitized or stationary state the control algorithm need only discriminate between static abuse events (such as door slams, hammer impacts, etc.) and severe impacts from other moving vehicles. Severe impacts from other moving vehicles while the vehicle is stationary are readily distinguishable from abuse events. When the vehicle is in motion, however, there is less concern for static abuse events such as door slams and the deployment algorithm is sensitized to respond to an impact with a stationary object. Discrimination of such impact signals is particularly useful for side impacts.

The present invention, therefore, provides an air bag system, which effectively discriminates side impact events by using vehicle speed input to determine if the vehicle is stationary or moving, and adjusting performance accordingly.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic view of an exemplary vehicle embodiment for use with the present invention; and

FIG. 2 is a graphical representation of a speed related deployment discrimination of an impact event according to the logic of the present invention.

### DETAILED DESCRIPTION OF THE PREFERRED EMBODIMENT

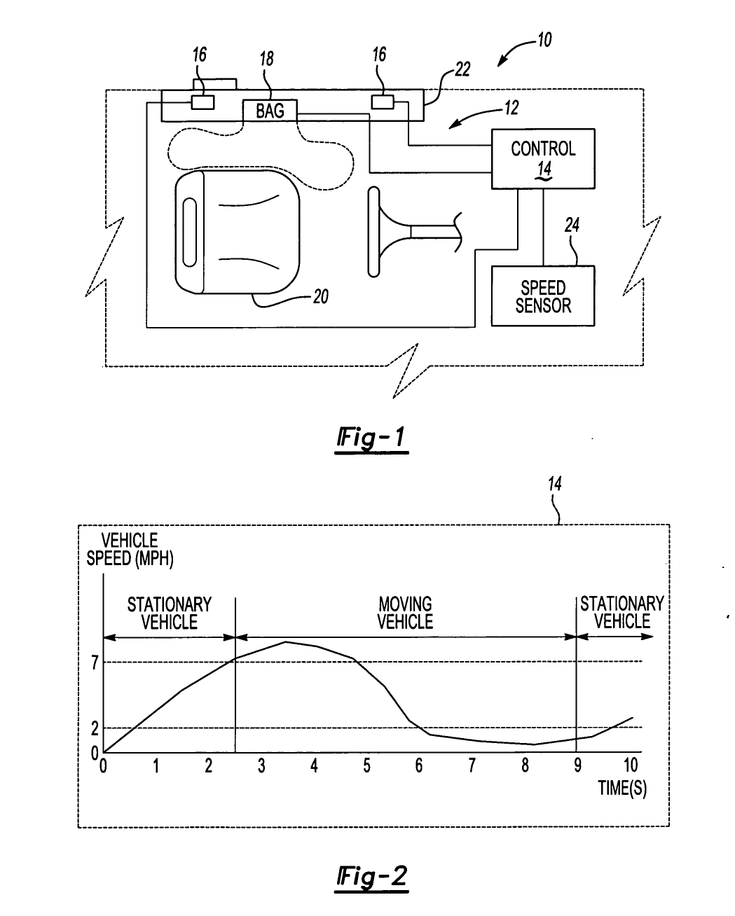

FIG. 1 illustrates a general schematic view of a vehicle 10 having an air bag system 12. The air bag system 12 generally includes a controller 14, one or more remote satellite sensors 16, a vehicle speed sensor 24 and a deployable air bag 18. Preferably, the air bag 18 is a side air bag located to the side of a vehicle seat 20. It should be understood that other air bag arrangements and sensor locations will likewise benefit from the present invention.

The satellite sensor 16 communicates with the controller 14 to sense a deploy event such as a side impact. In response to physically-based signals issued by the satellite sensor 16 the controller 14 determines whether to deploy the air bag 18 through deployment decision logic stored in the controller 14. The satellite sensor 16 is preferably located in a side 22 of the vehicle 10 adjacent the related air bag 18. Some common locations are on b-pillars, c-pillars, or within the doors. Other locations and sensor suites will also benefit from the present invention. Floor mounted sensors may not be preferred as they may be susceptible to localized abuse from road debris while the vehicle is in motion.

Side impacts with significant intrusion, such as vehicle side contact with a rigid stationary object such as a pole may be severe and could be harmful to occupants. Discrimination of a side impact may be difficult for conventional air bag systems as the intrusion of a rigid object through soft sheet metal such as a vehicle door may not generate a large signal to accelerometer sensors unless the intruding object directly strikes them.

It is not possible for a stationary vehicle to crash into a stationary object. While stationary, the concern is only that other objects may contact the vehicle. In the desensitized or stationary state the control algorithm need only discriminate between relatively minor static abuse events (such as door slams, hammer impacts, etc.) and relatively severe impacts from other moving vehicles. Severe impacts from other moving vehicles while the vehicle is stationary are readily distinguishable from abuse events. When the vehicle is in motion, however, there is less concern for static abuse events such as door slams such that the deployment algorithm is sensitized to respond to an impact with a stationary object. Refined discrimination of such impact signals is particularly useful for side impacts.

The sensitivity of the deployment algorithm decision may be adjusted in a multitude of ways. The deployment algorithm decision can be adjusted, for example, by adjusting the safing or plausibility level or a combination of both. Alternatively or in addition, provisions for two sets of parameters or a scaling factor determines a multiple of different sensitivity levels. Alternatively or in addition, particular algorithm terms are enabled or disabled in response to the vehicle situation.

For more than one sensor per vehicle side, one way to desensitize the system 12 is by requiring a certain level of input from more than one sensor. In this way, the threat of local impacts to one sensor is completely removed without sacrificing performance on severe vehicle impacts that do give significant levels on more than one sensor.

FIG. 2 is a graphical representation of the logic for determining if the vehicle is stationary or moving using vehicle speed information. The graph represents logic stored within the controller 14 for deployment of the air bag 18 in response to signals from the satellite sensor 16 and the vehicle speed sensor 24 utilized by the deployment algorithm. It should be understood that speed information is readily available from various vehicle instrumentation.

The vehicle speed information permits the controller 14 to determine if the vehicle is moving or stationary. The logic for deployment discrimination preferably relates the vehicle speed to a threshold for a period of time. If the vehicle speed is below a threshold (near zero mph) for a predetermined amount of time then the vehicle is considered to be stationary by the controller 14. If the vehicle speed exceeds a threshold then the vehicle is considered to be in motion. As illustrated in FIG. 2, a speed less than 2 mph for 3 seconds indicates a stationary vehicle and a speed greater than 7 mph indicates a vehicle in motion. It should be understood that other thresholds will benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason, the following claims should be studied to determine the true scope and content of this invention.

1. A method of deployment discrimination for an air bag deployment command comprising the steps of:
(1) determining whether a vehicle is in motion; and
(2) selectively sensitizing a deployment algorithm decision threshold in response to said step (1).

2. A method as recited in claim 1, wherein said step (1) further comprises the step of:
determining whether the vehicle is traveling above a predetermined speed.

3. A method as recited in claim 1, wherein said step (1) further comprises the step of:
determining whether the vehicle is traveling below a predetermined speed for a predetermined time.

4. A method as recited in claim 1, wherein said step (2) further comprises the step of:
adjusting a safing level of deployment algorithm decision threshold.

5 A method as recited in claim 1, wherein said step (2) further comprises the step of:
adjusting a plausibility level of deployment algorithm decision threshold.

6. A method as recited in claim 1, wherein said step (2) further comprises the step of:
requiring a predetermined input level form a multiple of satellite sensors.

7. A method of deployment discrimination for an air bag deployment command comprising the steps of:
(1) measuring a vehicle speed;
(2) determining whether a vehicle is in motion in response to said step (1); and
(3) selectively sensitizing a deployment algorithm decision threshold in response to said step (2).

8. A method as recited in claim 7, wherein said step (1) further comprises the step of:
determining whether the vehicle is traveling above a predetermined speed.

9. A method as recited in claim 7, wherein said step (1) further comprises the step of:
determining whether the vehicle is traveling below a predetermined speed for a predetermined time.
